(19) United States
(12) Patent Application Publication
(10) Pub. No.: US 2008/0054808 A1
(43) Pub. Date: Mar. 6, 2008

(54) Plasma display panel

(76) Inventors: Ho-Young Ahn, Suwon-si (KR); Won-Ju Yi, Suwon-si (KR); Kyoung-Doo Kang, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/892,592

(22) Filed: Aug. 24, 2007

(30) Foreign Application Priority Data
Aug. 29, 2006 (KR) 10-2006-0082305

(51) Int. Cl. H01J 17/49

(52) U.S. Cl. 313/586

(57) ABSTRACT

A plasma display panel includes first and second substrates facing each other, a first barrier rib structure between the first and second substrates, the first barrier rib structure including first and second barrier rib portions in communication with each other, a second barrier rib structure on the second substrate, the second barrier rib structure aligned with the first barrier rib portion to define a plurality of discharge cells, a plurality of discharge electrodes, each discharge electrode including a discharge part in the first barrier rib portion, a terminal part in communication with the second barrier rib portion, and a connection part between the discharge and terminal parts, a signal transmitting member with conductive wires, the conductive wires being connected to the terminal parts, a support part between the second substrate and the second barrier rib portion of the first barrier rib structure, and photoluminescent layers in the discharge cells.

### BACKGROUND OF THE INVENTION

1. Field of the Invention

Embodiments of the present invention relate to a plasma display panel. More particularly, embodiments of the present invention relate to a plasma display panel having a structure capable of minimizing barrier rib damage upon attachment of a signal transmitting member thereto.

2. Description of the Related Art

Plasma display panels (PDP) refer to display devices capable of displaying images using gas discharge phenomenon, i.e., use of voltage to trigger ultraviolet light and excite a photoluminescent material in order to emit visible light to form images. A conventional PDP may include front and a rear substrates, a plurality of barrier ribs therebetween to define discharge cells with discharge gas, discharge electrodes to facilitate voltage application, and a circuit board to operate the PDP. The discharge electrodes may be electrically connected to the circuit board via a signal transmitting member. However, application of force to physically connect the signal transmitting member to the discharge electrodes may result in excessive strain on portions of the PDP adjacent to the signal transmitting member, thereby triggering potential manufacturing failures, e.g., deformation and/or breakage of barrier ribs, and an increase of overall manufacturing costs.

### SUMMARY OF THE INVENTION

The present invention is therefore directed to a plasma display panel (PDP), which substantially overcomes one or more of the disadvantages of the related art.

It is therefore a feature of an embodiment of the present invention to provide a PDP structure exhibiting minimized manufacturing failures upon attachment of a signal transmitting member thereto.

At least one of the above and other features and advantages of the present invention may be realized by providing a PDP including first and second substrates facing each other, a first barrier rib structure between the first and second substrates, the first barrier rib structure including first and second barrier rib portions in communication with each other, a second barrier rib structure on the second substrate, the second barrier rib structure being aligned with the first barrier rib portion to define a plurality of discharge cells, a plurality of discharge electrodes, each discharge electrode having a discharge part in the first barrier rib portion, a terminal part in communication with the second barrier rib portion, and a connection part between the discharge and terminal parts, a signal transmitting member with conductive wires, the conductive wires being connected to the terminal parts of the discharge electrodes, a support part between the second substrate and the second barrier rib portion of the first barrier rib structure, and photoluminescent layers in the discharge cells. The signal transmitting member may be a flexible printed cable or a tape carrier package.

The second barrier rib portion may be connected to an edge of the first barrier rib portion. The terminal parts may be on the second barrier rib portion. The conductive wires may be on the terminal parts and parallel thereto. The PDP may further include an anisotropic conductive film between the conductive wires and the terminal parts. The photoluminescent layers may be in communication with the second barrier rib structure. The PDP may further include grooves on the first substrate and/or the second substrate, the grooves including the photoluminescent layers.

The support part may overlap with the terminal parts. The support part may completely overlap with the terminal parts. The support part may be shorter than the second barrier rib portion. The support part may be a dielectric layer.

The first substrate may be shorter than the second substrate. The first substrate may partially overlap with the second barrier rib portion. The PDP may further include a frit layer between the first substrate and second barrier rib portion and/or between the second substrate and the second barrier rib portion. The first and second barrier rib portions may have a sheet structure. The first barrier rib structure may include protective layers on at least a portion of inner surfaces of the discharge cells. The discharge parts may surround at least a portion of each of the discharge cells. The discharge parts may completely surround each of the discharge cells. The discharge parts may be circular or stripe-shaped.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of a plasma display panel according to an embodiment of the present invention;

FIG. 2 illustrates a cross-sectional view along line II-II of FIG. 1;

FIG. 3 illustrates a cross-sectional view along line III-III of FIG. 2; and

FIG. 4 illustrates a perspective view of a second substrate of a plasma display panel according to another embodiment of the present invention.

### DETAILED DESCRIPTION OF THE INVENTION

Korean Patent Application No. 10-2006-0082305, filed on Aug. 29, 2006, in the Korean Intellectual Property Office, and entitled: “Plasma Display Panel (PDP),” is incorporated by reference herein in its entirety.

Embodiments of the present invention will now be described more fully with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer, element or substrate, it can be directly on the other layer or substrate, or intervening layers or elements may also be present. Further, it will be understood that when a layer or element is referred to as being “under” another layer or element, it can be directly under, or one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

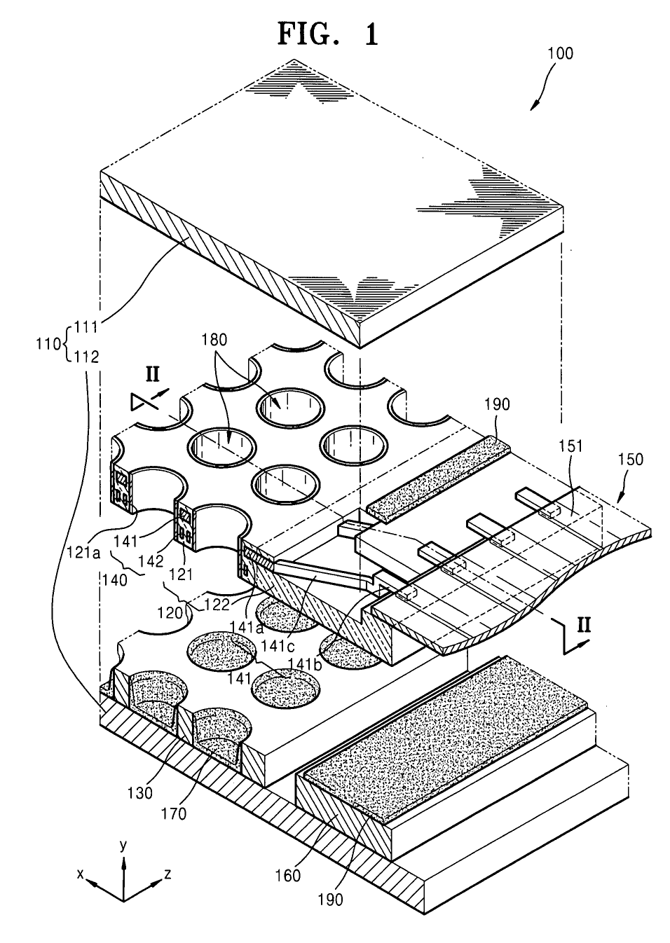

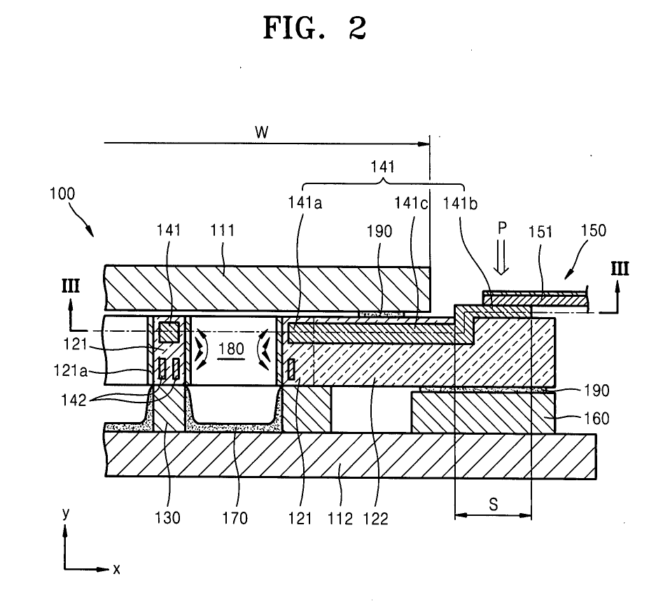

An exemplary embodiment of a plasma display panel (PDP) according to the present invention will be described more fully with reference to FIGS. 1-3. As illustrated in FIGS. 1-2, a PDP 100 may include a pair of substrates 110, a first barrier rib structure 120, a second barrier rib structure 130, a plurality of discharge electrodes 140, a signal transmitting member 150, a support part 160, and a plurality of phosphor layers 170. It should be noted, however, that even though the PDP is described with respect to a two-electrode-type PDP, other types of PDP, e.g., AC type three-electrode PDP, are within the scope of the present invention.

The pair of substrates 110 of the PDP 100 may include a first substrate 111 and a second substrate 112. The first and second substrates 111 and 112 may be spaced apart by a predetermined distance, and may face each other. The first substrate 111 may be shorter than the second substrate 112 along the x-axis to expose portions of the discharge electrodes 140 and to facilitate electrical connection thereof to the signal transmitting member 150, as will be discussed in detail below. The first substrate 111 may have a length W along the x-axis.

At least one of the first and second substrates 111 and 112 may be transparent, e.g., formed of glass, to facilitate visible light transmittance therethrough. For example, the first substrate 111 may be transparent. Alternatively, if the first substrate 111 is formed of an opaque material, the second substrate 112 may be formed of a transparent material. In yet another alternative, both the first and second substrates 111 and 112 may be formed of a transparent material. In still another alternative, the first and second substrates 111 and 112 may be formed of a translucent material, and may include a color filter.

The first barrier rib structure 120 of the PDP 100 may have a sheet structure, i.e., a flat structure in the xz-plane having a substantially uniform height along the y-axis. The first barrier rib structure 120 may be formed of a dielectric material, e.g., lead oxide (PbO), boron oxide (B₂O₃), silicon oxide (SiO₂), and so forth. The first barrier rib structure 120 may be interposed between the first and second substrates 111 and 112, and may include first and second barrier rib portions 121 and 122. The first and second barrier rib portions 121 and 122 may be attached to each other to form the sheet structure, and may be formed of the same dielectric material or not. If different materials are used to form the first and second barrier rib portions 121 and 122, a dielectric constant of each of the first and second barrier rib portion 121 and 122 may be adjusted.

The first barrier rib portion 121 may define upper portions of a plurality of discharge cells 180 in a central portion of the first barrier rib structure 120, i.e., a display region, to facilitate image display. The first barrier rib portion 121 may also define dummy cells (not shown), i.e., cells that do not display images due to lack of electrodes and/or phosphor layers therein, between the discharge cells 180. The first barrier rib portions 121 may substantially minimize or prevent conduction between the discharge electrodes 140 when a sustain discharge is generated. Additionally, the first barrier rib portions 121 may minimize or prevent damage to the discharge electrodes 140 caused by collisions of charged particles therewith, thereby accumulating wall charges.

The second barrier rib portion 122 may be in communication with the first barrier rib portions 121. For example, the second barrier rib portions 122 may be disposed in at least one peripheral portion of the first barrier rib structure 120, e.g., may be connected to an edge of the first barrier rib portion 121. A portion of the dummy cells may be formed in the second barrier rib portion 122.

The first barrier rib structure 120 may further include protective layers 121a on sidewalls of the first barrier rib portion 121, as illustrated in FIGS. 1-2. More specifically, the protective layers 121a may be disposed on inner surfaces of the discharge cells 180. The protective layers 121a may be formed of magnesium oxide (MgO) to prevent or to minimize damage to the discharge electrodes 140 and/or to the first barrier rib portions 121 from sputtering of plasma particles, secondary electrons discharge, and/or discharge voltage.

The second barrier rib structure 130 of the PDP 100 may be formed of a dielectric material, and may be disposed between the first barrier rib structure 120 and the second substrate 112. The second barrier rib structure 130 may define lower portions of the discharge cells 180, and may be aligned with the first barrier rib structure 120, so that the pair of substrates 110, the first barrier rib structure 120, and the second barrier rib structure 130 may define the discharge cells 180, as illustrated in FIGS. 1-2. The discharge cells 180 may have any suitable cross-sections in the xz-plane, e.g., circular, triangular, tetragonal, octagonal, oval, and so forth. Each of the first and second barrier rib structures 120 and 130 may provide a substantially similar cross-section to the discharge cells 180, thereby forming the discharge cells 180 with a uniform cross-section.

The discharge electrodes 140 of the PDP 100 may include first and second discharge electrodes 141 and 142 spaced apart from one another, and may be at least partially embedded within the first barrier rib portion 121. For example, as illustrated in FIGS. 1-2, the first discharge electrodes 141 may be disposed in an upper portion of the first barrier rib portion 121, and the second discharge electrodes 142 may be disposed in a lower portion of the first barrier rib portion 121. The first discharge electrodes 141 may include discharge parts 141a, terminal parts 141b, and connection parts 141c. The second discharge electrodes 142 may cross the first discharge electrodes 141, i.e., may be oriented in a perpendicular direction thereto, and may be symmetrical to the first discharge electrodes 141. Accordingly, the second discharge electrodes 142 may include discharge parts (not shown), terminal parts (not shown), and connection parts (not shown) having a substantially similar structure to the discharge parts 141a, terminal parts 141b, and connection parts 141c, respectively, of the first discharge electrodes 141. Each of the first and second discharge electrodes 141 and 142 may be disposed along the x-axis and the z-axis, respectively. Accordingly, the terminal parts 141b of the first discharge electrodes 141, for example, may form an array having a stripe pattern positioned along the z-axis, as illustrated in FIG. 1.

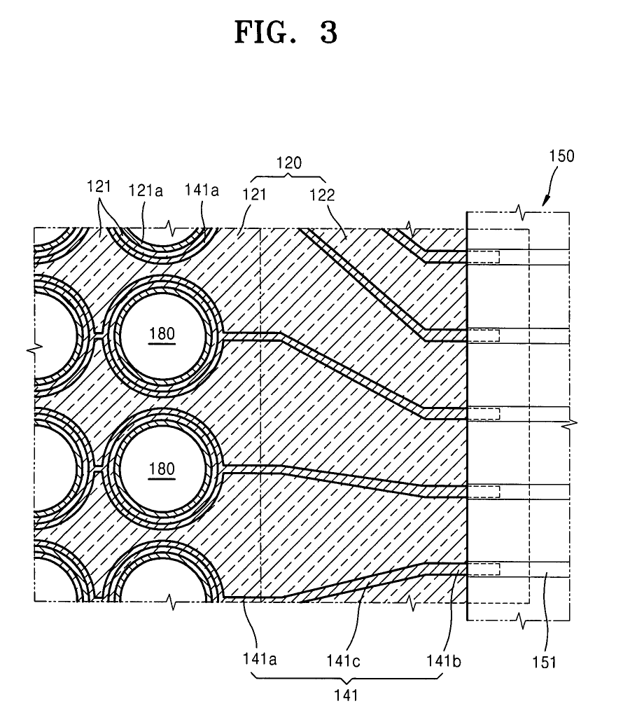

The discharge parts 141a of the first discharge electrodes 141 and the discharge parts of the second discharge electrodes 142 may be disposed inside the first barrier rib portion 121 to trigger a discharge in response to an address voltage and/or a sustain discharge voltage depending on a state of the discharge cell 180. More specifically, the discharge parts 141a of the first discharge electrodes 141 and the discharge parts of the second discharge electrodes 142 may be configured to surround each discharge cell 180 to provide a sustain discharge therein directed radially toward a center thereof with respect to an inner surface of the discharge cell 180. In other words, the discharge parts 141a of the first discharge electrodes 141 and the discharge parts of the second discharge electrodes 142 may be shaped in any suitable structure to symmetrically surround the discharge cells 180. For example, the first and second discharge electrodes 141 and 142 may be ring-shaped, as illustrated in FIG. 3. However, polygonal structures of the first and second discharge electrodes 141 and 142, e.g., triangular, pentagonal, and so forth, are within the scope of the present invention. Accordingly, a single discharge electrode 141, for example, may include a discharge part 141a having a plurality of symmetrical structures, e.g., circles, to surround a plurality of the discharge cells 180 in a single row or column.

Alternatively, the first and second discharge electrodes 141 and 142 may be stripe-shaped, and may be buried in the first barrier rib portion 121, thereby providing a discharge path of opposite discharge rather than a surface discharge. In another alternative, the discharge parts 141a of the first and second discharge electrodes 141 and the discharge parts of the second discharge electrodes 142 may partially surround the discharge cells 180, e.g., configured to have a C-shape. The discharge parts 141a of the first discharge electrodes 141 and the discharge parts of the second discharge electrodes 142 may be formed of a conductive and anti-resistant metal, e.g., silver (Ag), aluminum (Al), and so forth, such that the PDP 100 may provide a quick response to a discharge, a non-distorted signal, and a reduced power consumption.

The terminal parts 141b of the first discharge electrodes 141 may be arranged in communication with the second barrier rib portion 122. For example, the terminal parts 141b may be disposed on an upper surface of the second barrier rib portion 122 to facilitate electrical connection thereof to the transmitting member 150. More specifically, as illustrated in FIG. 2, the terminal parts 141b may be positioned between the second barrier rib portion 122 and conductive wires 151 of the signal transmitting member 150. As further illustrated in FIG. 2, the terminal parts 141b may be formed to have a rotated L-shape. For example, the terminal parts 141b may have horizontal portions on the second barrier rib portion 122 and in parallel thereto, and vertical portions in a downward direction with respect to the horizontal portions, i.e., formed inside the second barrier rib portion 122. Accordingly, a lower surface S of the terminal parts 141b may be non-uniform. In other words, lower surface S may be formed in the yz and xz planes to facilitate a connection between the terminal parts 141b and the connection parts 141c.

The connection parts 141c of the first discharge electrodes 141 may be buried in the second barrier rib portion 122. Each connection part 141c may electrically connect a respective discharge part 141a to a corresponding terminal part 141b. It should be noted, however, that other configurations of the connection parts 141c, e.g., the connection parts 141c may be disposed on the upper surface of the second barrier rib portion 122, are within the scope of the present invention.

The signal transmitting member 150 of the PDP 100 may be electrically connected to an operating circuit (not shown) that operates the PDP 100, and may be formed, e.g., of a flexible printed cable (FPC) or of a tape carrier package (TCP). The signal transmitting member 150 may include the conductive wires 151 to transfer electrical signals. Accordingly, the conductive wires 151 may be disposed on the terminal parts 141b of the first discharge electrodes 141 and on the terminal parts of the second discharge electrodes 142, and in parallel thereto. A load P, as illustrated in FIG. 2, may be applied in a downward direction to the conductive wires 151 in order to electrically connect the conductive wires 151 to the terminal parts 141b of the first discharge electrodes 141 and to the terminal parts of the second discharge electrodes 142 via, e.g., an anisotropic conductive film.

The support part 160 of the PDP 100 may be disposed between the second substrate 112 and the second barrier rib portion 122. More specifically, the support part 160 may be formed on the second substrate 112. The support part 160 may be thinner than the second barrier rib structure 130, i.e., as measured along the y-axis, so that a frit layer 190 may be adhered between an upper surface of the support part 160 and the second barrier rib portion 122. A combined thickness of the frit layer 190 and the support part 160 may substantially equal a thickness of the second barrier rib structure 130.

In detail, the support part 160 may be shorter than the second barrier rib portion 122, i.e., as measured along the x-axis, and may be positioned to overlap with the lower surface S of the terminal parts 141b along the x-axis. Further, the support part 160 may be sufficiently wide along the z-axis to overlap with the array of the terminal parts 141b, as illustrated in FIG. 1. Accordingly, the support part 160 may support the second barrier rib portion 122 upon application of the load P to the terminal parts 141b, thereby substantially minimizing or preventing damage to the second barrier rib portion 122. More specifically, the support part 160 may provide a structure between the second barrier rib portion 122 and the second substrate 112 capable of preventing deformation or breakage of the barrier rib portion 122 upon application of an excessive force thereto. The support part 160 may be formed of any suitable material, e.g., a dielectric material.

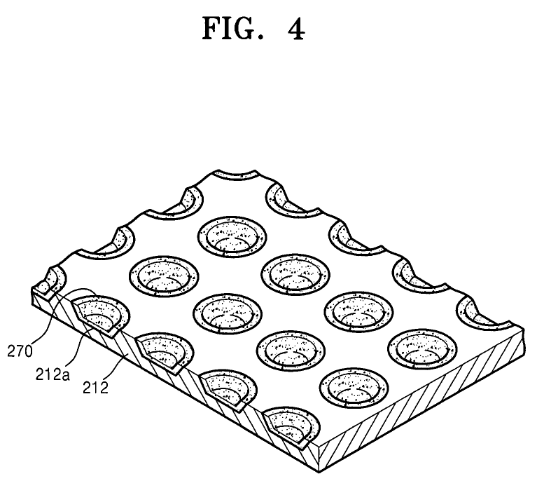

The photoluminescent layers 170 of the PDP 100 may be formed on inner surfaces of the discharge cells 180, e.g., lower portions of discharge cells 180 defined by the second barrier rib structure 130. The photoluminescent layers 170 may include a red light emitting phosphor, e.g., Y(V,P)O₄:Eu, a green light emitting phosphor, e.g., Zn₂SiO₄:Mn or YBO₃:Tb, and/or a blue light emitting phosphor, e.g., BAM:Eu. It should be noted, however, that other configurations of photoluminescent layers are within the scope of the present invention. For example, as illustrated in FIG. 4, photoluminescent layers 270 may be disposed in grooves 212a formed in either a first substrate or a second substrate 212, and in communication with discharge cells (not shown).

The frit layer 190 of the PDP may be adhered between the second barrier rib portion 122 and the support part 160, as described above. Additionally, the frit layer 190 may be disposed between the first substrate 111 and the second barrier rib portion 122 to seal the PDP 100 via a baking process. Other configurations of the frit layer 190 in order to seal the PDP 100, e.g., the frit layer 190 may be disposed between the second barrier rib portion 122 and the second substrate 112, are within the scope of the present invention. Accordingly, a thickness of the frit layer 190 may correspond to a thickness of a gap being sealed by the frit layer 190. Once the PDP 100 is sealed, the discharge cells 180 may be filled with a discharge gas, e.g., neon (Ne), xenon (Xe), or a mixture thereof.

A manufacturing method of the PDP 100 may be as follows. The first and second barrier rib structures 120 and 130 may be formed sequentially to define the discharge cells 180, followed by coating of the photoluminescent layers 170 on the inner surface of the discharge cells 180. Next, the PDP 100 may be sealed using the frit layer 190, followed by injection of the discharge gas into the discharge cells 180. Finally, the signal transmitting member 150 may be attached to the discharge electrodes 140 of the PDP 100.

The first barrier rib structure 120 may be formed to have a sheet structure. More specifically, the discharge parts 141a and the connection parts 141c of the first discharge electrodes 141 and the discharge parts and the connection parts of the second discharge electrodes 142 may be formed between layers of a dielectric material, i.e., stacked to form a sheet. Next, a central area of the sheet structure may be processed to punch out predetermined portions thereof to form upper portions of the discharge cells 180, thereby completing the first barrier rib portion 121. A peripheral area of the sheet structure, i.e., an area including the connection parts 141c of the first discharge electrodes 141 and the connection parts of the second discharge electrodes 142, may remain unpunched to form the second barrier rib portion 122. Once the first and second barrier rib portions 121 and 122 are formed, the terminal parts 141b of the first discharge electrodes 141 and the terminal part of the second discharge electrodes 142 may be formed on the second barrier rib portion 122, and in communication with outer edges of the connection parts 141c of the first discharge electrodes 141 and with the connection part of the second discharge electrodes 142, respectively. The protective layers 121a may be formed of magnesium oxide (MgO) on inner surface of the upper portions of the discharge cells 180 using, e.g., vacuum deposition.

The second barrier rib structure 130 may be formed of a dielectric material on the second substrate 112 using, e.g., screen printing, sand blasting, and so forth. The second barrier rib structure 130 may be shaped to form the lower portions of the discharge cells 180. Simultaneously, the support part 160 may be formed on at least one peripheral portion of the second substrate 112. The support part 160 and the second barrier rib structure 130 may be formed simultaneously in order to reduce manufacturing time and costs. Accordingly, the support part 160 may be formed of a dielectric material by, e.g., screen printing, sand blasting, and so forth.

The photoluminescent layers 170 may be disposed on inner surfaces of the discharge cells 180, e.g., coating a phosphorescent material on sidewalls of the second barrier rib structure 130 and on portions of an upper surface of the second substrate 112. Next, the first barrier rib structure 120 may be disposed above the second barrier rib structure 130, so that upper and lower portions of the discharge cells 180 may align to form the discharge cells 180. Similarly, the support part 160 may be aligned to overlap with the terminal parts 141b. The frit layer 190 may be disposed between the first substrate 111 and the second barrier rib portion 122 and/or between the second barrier rib portion 122 and the support part 160. Heat may be applied to the frit layer 190 to seal the PDP 100. Once the PDP 100 is sealed, impurities may be exhausted from the PDP 100, followed by injection of the discharge gas into the discharge cells 180 of the PDP 100.

Once injection of the discharge gas into the PDP 100 is complete, the terminal parts 141b may be connected to the conductive wires 151 of the signal transmitting member 150 using, e.g., the anisotropic conductive film. More specifically, the load P, as illustrated in FIG. 2, may be applied to the signal transmitting member 150 to facilitate adhesion between the terminal parts 141b and the conductive wires 151. Despite a shearing force and a bending moment applied in the downward direction by the load P on the second barrier rib portion 122 of the first barrier rib structure 120, the second barrier rib portion 122 may remain undamaged due to support of the support part 160.

Operation of the PDP 100 may be as follows. An external source may be used to apply an address voltage between the first and second discharge electrodes 141 and 142 to generate an address discharge, i.e., operational discharge cells of the discharge cells 180 may be selected. Next, a discharge sustain voltage may be applied between first and second discharge electrodes 141 and 142 of the selected discharge cells 180 to trigger a sustain discharge therein, i.e., movement of wall charges accumulated on surfaces of the first barrier rib portions 121. The sustain discharge may place the discharge gas at a high energy level, thereby facilitating emission of ultraviolet (UV) light upon decrease of the high energy level thereof. The UV light may excite the photoluminescent layers 170 to emit visible light towards the first substrate 111, thereby forming images.

The PDP 100 according to embodiments of the present invention may be advantageous in providing a support part capable of absorbing a downward momentum applied to the first barrier rib structure. Such a support structure may substantially minimize deformation and/or damage to the first barrier rib structure during attachment of elements, e.g., signal transmitting member, thereon via load application. Reduced damage to the first barrier rib structure may decrease manufacturing failure rate and manufacturing costs. Further, the PDP 100 may include discharge electrodes having discharge parts capable of surrounding the discharge cells to provide an increased discharge area with a radially uniform discharge in the discharge cells, thereby increasing light-emitting brightness and efficiency of the PDP 100. Accordingly, the PDP 100 may exhibit improved quality at reduced manufacturing costs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as defined by the following claims.

What is claimed is:

1. A plasma display panel (PDP), comprising:
first and second substrates facing each other;
a first barrier rib structure between the first and second substrates, the first barrier rib structure including first and second barrier rib portions in communication with each other;
a second barrier rib structure on the second substrate, the second barrier rib structure being aligned with the first barrier rib portion to define a plurality of discharge cells;
a plurality of discharge electrodes, each discharge electrode including a discharge part in the first barrier rib portion, a terminal part in communication with the second barrier rib portion, and a connection part between the discharge and terminal parts;
a signal transmitting member including conductive wires, the conductive wires being connected to the terminal parts of the discharge electrodes;
a support part between the second substrate and the second barrier rib portion of the first barrier rib structure; and
photoluminescent layers in the discharge cells.

2. The PDP as claimed in claim 1, wherein the second barrier rib portion is connected to an edge of the first barrier rib portion.

3. The PDP as claimed in claim 2, wherein the first substrate is shorter than the second substrate.

4. The PDP as claimed in claim 3, wherein the first substrate partially overlaps with the second barrier rib portion.

5. The PDP as claimed in claim 2, wherein the terminal parts are on the second barrier rib portion.

6. The PDP as claimed in claim 5, wherein the conductive wires are on the terminal parts and parallel thereto.

7. The PDP as claimed in claim 1, wherein the first and second barrier rib portions have a sheet structure.

8. The PDP as claimed in claim 1, wherein the first barrier rib structure includes protective layers on at least a portion of inner surfaces of the discharge cells.

9. The PDP as claimed in claim 1, wherein the discharge parts surround at least a portion of each of the discharge cells.

10. The PDP as claimed in claim 9, wherein the discharge parts completely surround each of the discharge cells.

11. The PDP as claimed in claim 1, wherein the discharge parts are circular or stripe-shaped.

12. The PDP as claimed in claim 1, wherein the signal transmitting member is a flexible printed cable or a tape carrier package.

13. The PDP as claimed in claim 1, further comprising an anisotropic conductive film between the conductive wires and the terminal parts.

14. The PDP as claimed in claim 1, wherein the support part overlaps with the terminal parts.

15. The PDP as claimed in claim 14, wherein the support part completely overlaps with the terminal parts.

16. The PDP as claimed in claim 1, wherein the support part is shorter than the second barrier rib portion.

17. The PDP as claimed in claim 1, further comprising a frit layer between the first substrate and second barrier rib portion and/or between the second substrate and the second barrier rib portion.

18. The PDP as claimed in claim 1, wherein the support part is a dielectric layer.

19. The PDP as claimed in claim 1, wherein the photoluminescent layers are in communication with the second barrier rib structure.

20. The PDP as claimed in claim 1, further comprising grooves on the first substrate and/or the second substrate, the grooves including the photoluminescent layers.
